(19) United States
(12) Patent Application Publication
(10) Pub. No.: US 2026/0291899 A1
(43) Pub. Date: Sep. 24, 2026

(54) INFORMATION PROCESSING APPARATUS, DISPLAY SYSTEM, AND DISPLAY METHOD

(71) Applicant: SHARP KABUSHIKI KAISHA, Sakai City (JP)

(72) Inventor: Hidemitsu IMAI, Sakai City (JP)

(21) Appl. No.: 19/563,176

(22) Filed: Mar. 11, 2026

(30) Foreign Application Priority Data
Mar. 19, 2025 (JP) 2025-045642

(51) Int. Cl. H04L 51/046; H04L 51/02

(52) U.S. Cl. CPC H04L 51/046; H04L 51/02

(57) ABSTRACT

An information processing apparatus includes a display device and one or more controllers. The one or more controllers display, on the display device, a guidance screen for guiding use of a chat service, and display, on the guidance screen, a message for guiding the use of the chat service on a terminal device and a display for causing the guidance screen to transition to a chat screen of the chat service.

### BACKGROUND OF THE INVENTION

### Field of the Invention

The present disclosure relates to an information processing apparatus and the like. This application is based on Japanese Patent Application No. 2025-45642, filed in Japan on March 19, 2025, the entire contents of which are incorporated herein by reference.

### Description of the Background Art

For example, in an image forming apparatus, when an event such as an error occurs, a system is known in which explanatory information corresponding to the occurred event is displayed on a display screen of a terminal device by reading a two-dimensional code displayed on an operation screen of the image forming apparatus into the terminal device.

One of objects of the present disclosure is to provide, for example, an information processing apparatus and the like capable of appropriately providing a user with a usage screen of a chat service.

### SUMMARY OF THE INVENTION

An information processing apparatus of the present disclosure includes a display device and one or more controllers. The one or more controllers display, on the display device, a guidance screen for guiding use of a chat service, and display, on the guidance screen, a message for guiding the use of the chat service on a terminal device and a display for causing the guidance screen to transition to a chat screen of the chat service.

A display system of the present disclosure includes a server device capable of providing a chat service, an information processing apparatus that displays a guidance screen for guiding the use of the chat service, and a terminal device. The information processing apparatus displays, on the guidance screen, a message for guiding the use of the chat service on the terminal device and a display for causing the guidance screen to transition to a chat screen of the chat service.

A display method of the present disclosure includes a display step of displaying a guidance screen for guiding the use of a chat service, and a control step of displaying, on the guidance screen, a message for guiding the use of the chat service on a terminal device and a display for causing the guidance screen to transition to a chat screen of the chat service.

According to the present disclosure, it is possible to, for example, provide an information processing apparatus and the like capable of appropriately providing the user with a usage screen of a chat service.

### BRIEF DESCRIPTION OF THE DRAWINGS

FIG. 1 is a diagram for explaining an overview of a system in a first embodiment.

FIG. 2 is a diagram for explaining a hardware configuration of the system in the first embodiment.

FIG. 3 is a diagram for explaining a hardware configuration of the system in the first embodiment.

FIG. 4A is a diagram for explaining a software configuration of an image forming apparatus in the first embodiment.

FIG. 4B is a diagram for explaining a software configuration of a server device in the first embodiment.

FIG. 5 is a diagram for explaining an example of management information in the first embodiment.

FIG. 6 is a diagram for explaining a flow of processing in the first embodiment.

FIG. 7 is a diagram for explaining a flow of processing in the first embodiment.

FIG. 8 is a diagram for explaining a flow of processing in the first embodiment.

FIG. 9A is a diagram for explaining an operation example in the first embodiment.

FIG. 9B is a diagram for explaining an operation example in the first embodiment.

FIG. 9C is a diagram for explaining an operation example in the first embodiment.

FIG. 10 is a diagram for explaining a hardware configuration of a system in a second embodiment.

FIG. 11 is a diagram for explaining a flow of processing in the second embodiment.

FIG. 12 is a diagram for explaining a flow of processing in the second embodiment.

FIG. 13 is a diagram for explaining an operation example in the second embodiment.

FIG. 14 is a diagram for explaining a flow of processing in a third embodiment.

FIG. 15 is a diagram for explaining a flow of processing in the third embodiment.

FIG. 16A is a diagram for explaining an operation example in the third embodiment.

FIG. 16B is a diagram for explaining an operation example in the third embodiment.

FIG. 16C is a diagram for explaining an operation example in the third embodiment.

### DETAILED DESCRIPTION OF THE PREFERRED EMBODIMENTS

Generally, when a method of operating an information processing apparatus such as an image forming apparatus is unknown or when a failure occurs, there exists a function of, for example, guiding a user to an FAQ (Frequently Asked Questions) or an instruction manual prepared on a manufacturer's web site or the like, and causing the user to browse the FAQ or the instruction manual on a terminal device possessed by the user. In order to find necessary information from the guided FAQ or the instruction manual, the user must perform a search using a search word or read the FAQ or the instruction manual, and there has been a problem that it takes time to reach the information the user wants to know.

In order to allow the user to reach the information the user wants to know in a short time, for example, a method is conceivable in which the user interacts in an interactive manner with a server device storing information of the FAQ or the instruction manual using a chat service. However, as a means for realizing the method, if only one of a means for interaction between the user and the server device via the terminal device possessed by the user and a means for interaction between the user and the server device via an operation screen of the information processing apparatus is provided, the chat service cannot be used when the user does not possess the terminal device, and when the information processing apparatus is an apparatus shared by a plurality of users, there is a problem that users other than the user using the chat service cannot use the information processing apparatus.

A system for solving such problems will be described below in the following embodiments with reference to the drawings. Note that the following embodiments are described as an example of the invention described in the claims, and the technical scope of the present disclosure is not limited to the descriptions of the following embodiments.

### 1 First Embodiment

### 1.1 Overview of System

The first embodiment will be described below. Note that in the first embodiment, the following will be described as an example. In the following embodiment, a case where the information processing apparatus is applied to an image forming apparatus will be described, but the present disclosure is also applicable to other apparatuses.

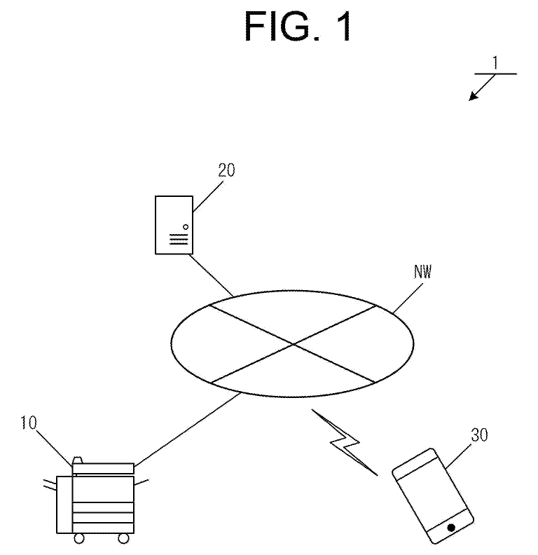

FIG. 1 is a diagram for explaining an overview of a system 1. The system 1 includes an image forming apparatus 10 and is connected to a network (NW). The image forming apparatus 10 is, for example, an apparatus called a multi-function peripheral or an MFP (Multifunction Peripheral/Printer/Product). For example, when the image forming apparatus 10 executes a job (printing job), the image forming apparatus 10 can form an image on paper, which is a recording medium. The image forming apparatus 10 can execute jobs for a plurality of processes such as copy processing, FAX processing, scan processing, and print processing as jobs to be executed.

The system 1 includes a server device 20. The server device 20 can provide, for example, a chat service and is connected to the network NW.

Here, the chat service is, for example, a service that mainly enables transmission and reception of text data in an interactive manner via a network. Note that the chat service may perform transmission and reception of image data and audio data in an interactive manner. In the present embodiment, the term "service" refers to the "chat service".

In the present embodiment, an input sentence input at the image forming apparatus 10 or the terminal device 30 may be transmitted to the server device 20, and a response sentence output from the server device 20 may be transmitted to the image forming apparatus 10 or the terminal device 30. For example, when a user inputs a question sentence as an input sentence at the image forming apparatus 10 or the terminal device 30, the server device 20 can transmit an answer sentence based on the question sentence as a response sentence to the image forming apparatus 10 or the terminal device 30. Note that the server device 20 may be one or a plurality of devices.

In the present embodiment, the question sentence refers to, for example, a sentence input by the user for obtaining information required by the user as an answer when the user does not know an operation method of the image forming apparatus 10 or when a failure occurs.

The answer sentence is a sentence output when the server device 20 provides an answer to the question sentence. These sentences may be referred to as messages. In addition to the answer sentence, the message may include, for example, a sentence (message) for notifying the user.

The sentence (message) may be input or displayed, for example, via a web browser or a chat application of the image forming apparatus 10 or the terminal device 30. The message may be displayed in text or may be input and output in audio.

The server device 20 may store information related to the image forming apparatus 10, such as an FAQ related to an operation method or a maintenance method of the image forming apparatus 10 and a manual (instruction manual) of the image forming apparatus 10. The server device 20 may be able to acquire information related to the image forming apparatus 10 from an external server. When receiving a question sentence input by the user at the image forming apparatus 10 or the terminal device 30, the server device 20 may, for example, search the FAQ or the manual and generate an answer sentence based on the obtained search result.

The server device 20 may transmit an answer sentence by a chatbot that generates an answer sentence using AI (Artificial Intelligence) such as, for example, a language model (preferably, information related to the image forming apparatus 10 has been learned by machine learning or the like). Here, the language model may be prepared by a service provider that constructs the system 1, or an external language model may be utilized.

As the language model to be utilized, for example, Large Language Models (LLM) such as GPT (registered trademark) (Generative Pre-trained Transformers, GPT-3, GPT-4, GPT-4o), PaLM (registered trademark) (Pathways Language Model), LLaMA (Large Language Model Meta AI), and tsuzumi (registered trademark) may be used.

As another usable language model different from the large language model, the server device 20 may store, for example, a small language model (SLM) as an edge LLM. That is, the system 1 may use a language model having so-called large training data (LLM) from an external server or the like as a language model, and may use a language model having less training data (SLM) than the large language model.

Furthermore, the system 1 includes a terminal device 30. The terminal device 30 is connected to, for example, the network NW. Note that the terminal device 30 can communicate with the image forming apparatus 10 using short-range wireless communication such as NFC (Near Field Communication).

The information processing apparatus of the present disclosure can be applied to, for example, information processing apparatuses such as smartphones and tablets, in addition to image forming apparatuses. The information processing apparatus may be a home appliance equipped with an IoT function (for example, an air conditioner, a refrigerator, a television, etc.), or may be a portable device or an in-vehicle device (for example, car navigation, etc.).

### 1.2 Hardware Configuration

### 1.2.1 Common Configuration

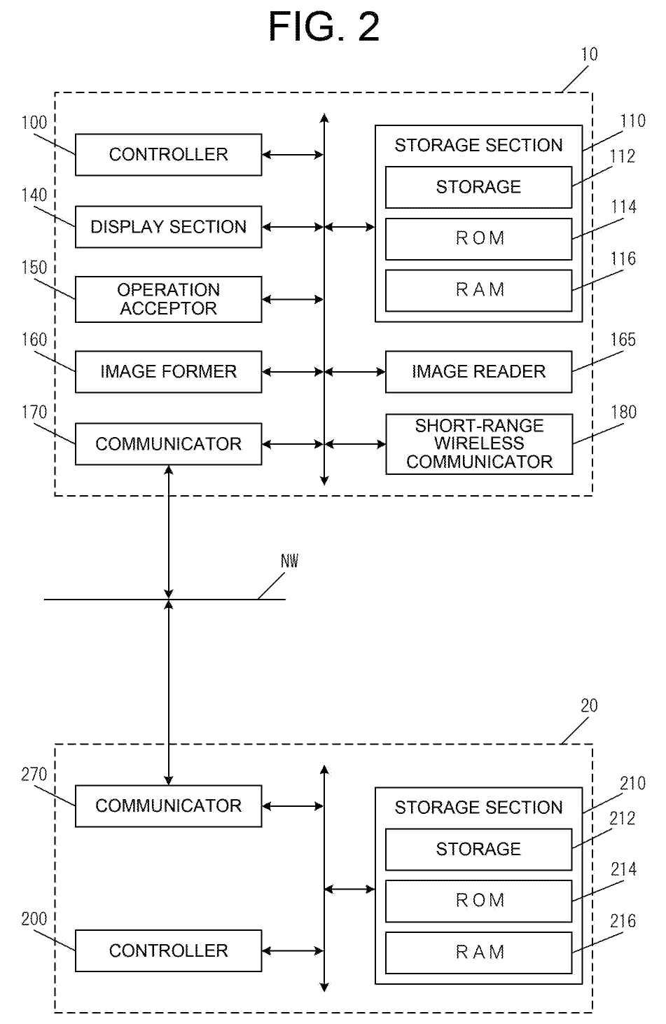

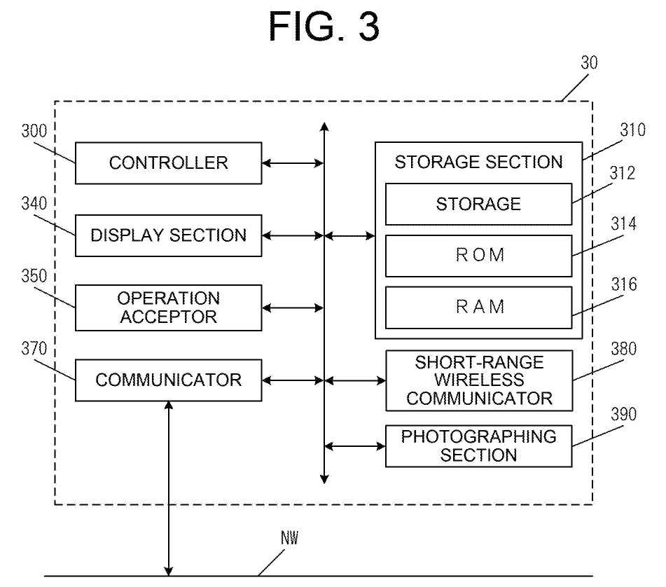

FIGS. 2 and 3 are diagrams for explaining the hardware configuration of each device in the present embodiment. The image forming apparatus 10, the server device 20, and the terminal device 30 each include at least one or more controllers, a storage section (storage, ROM: Read Only Memory, RAM: Random Access Memory), and a communicator. Each device has general functions as necessary.

Among the respective devices, the controller, the storage section, the display device, the operation acceptor, the communicator, and the short-range wireless communicator will be described below.

The controller (for example, controller 100, controller 200, controller 300) is a functional section for controlling the entire device. The controller realizes various functions by reading and executing various programs stored in the storage or the ROM. The controller may be realized by one or a plurality of control devices/arithmetic devices (CPU (Central Processing Unit), SoC (System on a Chip)).

The storage section (for example, storage section 110, storage section 210, storage section 310) is one or a plurality of storage devices in which various programs and various data necessary for operations of respective devices are stored. The storage section includes, for example, a storage, a ROM, and a RAM.

The storage (for example, storage 112, storage 212, storage 312) is a non-volatile storage device capable of storing programs and data. For example, the storage may be configured by a storage device such as an HDD (Hard Disk Drive) or an SSD (Solid State Drive). The storage may also be configured such as a USB (Universal Serial Bus) memory connectable as an external device. The storage may be, for example, a storage area on a cloud.

The ROM (for example, ROM 114, ROM 214, ROM 314) is a non-volatile memory capable of retaining programs and data even when power is turned off. The ROM may store, for example, firmware or initial applications of each device.

The RAM (for example, RAM 116, RAM 216, RAM 316) is a main memory mainly used when the controller of each device executes processing. The RAM is a rewritable memory that temporarily retains programs read from the storage of each device or the ROM of each device, and data including results during execution.

The display device (for example, display device 140, display device 340) is a display device capable of displaying various information and various screens such as an execution screen. The display device may be, for example, a display device such as a liquid crystal display (LCD), an organic EL (Organic Electro Luminescence) display, or an electrophoretic display. The display device also includes an interface to which a display device can be connected. For example, the display device may be configured by an external display device connected via HDMI (registered trademark) (High-Definition Multimedia Interface), DVI (Digital Visual Interface), or Display Port.

The operation acceptor (for example, operation acceptor 150, operation acceptor 350) is an operation device capable of accepting operation inputs from a user. For example, the operation acceptor may be software keys displayed on a touch panel integrated with the display device, or hardware keys such as operation buttons. The operation acceptor may also be an operation device such as a keyboard or a mouse. The operation acceptor may include an interface (for example, USB) to which an operation device can be connected. For example, each device may connect different operation devices (keyboard, mouse, etc.) via the interface.

The communicator (for example, communicator 170, communicator 270, communicator 370) is a communication interface for communicating with other devices. For example, the communicator may be a network interface connectable to a wireless LAN (Local area network), or may be a network interface connectable to Ethernet (registered trademark) by wire. The communicator may also be a communication device connectable to a mobile communication network such as, for example, LTE (Long Term Evolution)/4G/5G/6G.

The short-range wireless communicator (for example, short-range wireless communicator 180, short-range wireless communicator 380) is an interface for data communication with various external devices capable of using NFC. The short-range wireless communicator may communicate with various external devices by, for example, an NFC tag. The short-range wireless communicator may have a storage section separately from the storage section. In the present embodiment, the short-range wireless communicator uses an NFC tag, but as long as communication with various external devices is possible via short-range radio frequencies, other RF tags such as a UHF tag may be used, or Bluetooth (registered trademark) may be used.

### 1.2.2 Image Forming Apparatus

Next, a hardware configuration of the image forming apparatus 10 will be described with reference to FIG. 2.

The image former 160 forms an image on, for example, recording paper. The image former 160 includes, for example, an image carrier, forms a toner image on the image carrier, and forms an image by transferring the toner image on the image carrier onto recording paper. The image former 160 may be configured as an image forming apparatus such as a printer. The image former 160 may electronically form an image as an image file.

The image reader 165 reads a document (image) and outputs the document as image data. The image reader 165 is, for example, a scanner, and may be a reading device using a CCD (Charge Coupled Device), a CIS (Contact Image Sensor), or a CMOS (Complementary Metal-Oxide-Semiconductor) image sensor.

### 1.2.3 Terminal Device

Next, a hardware configuration of the terminal device 30 will be described with reference to FIG. 3.

The photographing section 390 reads an image and outputs the image as image data. The photographing section 390 is, for example, a camera or the like, and may be a photographing device using a CCD (Charge Coupled Device) or a CMOS (Complementary Metal-Oxide-Semiconductor) image sensor. In the present embodiment, the terminal device 30 has the photographing section 390, but for example, the terminal device 30 may not have the photographing section 390 and an external camera device or the like may be connected.

### 1.3 Software Configuration

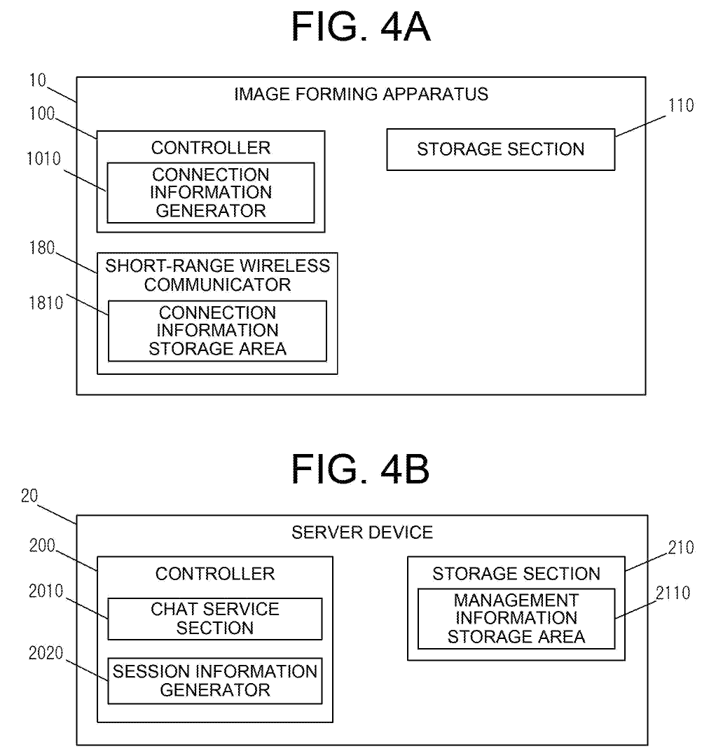

Configurations of main software in each device included in the system 1 will be described with reference to FIGS. 4A and 4B. FIG. 4A is a diagram showing the configuration of software of the image forming apparatus 10, and FIG. 4B is a diagram for explaining the configuration of main software of the server device 20. Note that the software configurations shown in FIGS. 4A and 4B mainly describe configurations necessary in the present embodiment, and other configurations are omitted.

### 1.3.1 Image Forming Apparatus

First, the configuration of main software of the image forming apparatus 10 will be described. For example, the one or more controllers 100 can realize a connection information generator 1010 by reading and executing programs stored in the storage section 110 (storage 112, ROM 114).

The connection information generator 1010 generates connection information including session information acquired from the server device 20. The connection information is information for the image forming apparatus 10 or the terminal device 30 to connect to the server device 20. In the connection information, for example, a URL or an IP address for connecting to the server device 20 may be stored, or information in which session information is added as a query parameter may be stored.

Here, in the present embodiment, the session information is information for the image forming apparatus 10 or the terminal device 30 to manage a session of the chat service with the server device 20. The session information may include, for example, an access token, or may include various states (for example, a state of a user, states of transmission and reception of messages of a user, a state of a device, etc.).

As a method for the connection information generator 1010 to generate connection information, for example, the following methods are conceivable.
(1) The connection information generator 1010 acquires the URL or the IP address of the server device 20. Then, the connection information generator 1010 generates, as connection information, information in which session information is added as a query parameter to the URL or the IP address of the server device 20.
(2) The connection information generator 1010 reads the URL or the IP address of the server device 20, and generates, as connection information, information in which session information and model information (for example, device name of the image forming apparatus 10, software version, model series, option state, etc.) are added as query parameters to the URL or the IP address of the server device 20. Thereby, for example, the server device 20 can output an answer sentence corresponding to information for each model of the image forming apparatus 10.
(3) The connection information generator 1010 reads the URL or the IP address of the server device 20, and generates, as connection information, information in which session information, an error content (for example, toner out, paper jam, etc.), and a user operation (for example, terms that a user wants to know, etc.) are added as query parameters to the URL or the IP address of the server device 20. Thereby, for example, the server device 20 can output an answer sentence for a case where an error occurs in the image forming apparatus 10.

The short-range wireless communicator 180 has a connection information storage area 1810 for storing connection information. The connection information is information that the terminal device 30 can acquire by short-range wireless communication via the short-range wireless communicator 180. The terminal device 30 connects to the server device 20 based on the acquired connection information.

### 1.3.2 Server Device

Next, the configuration of main software of the server device 20 will be described. For example, the one or more controllers 200 can realize a chat service section 2010 and a session information generator 2020 by reading and executing programs stored in the storage section 210 (storage 212, ROM 214).

The chat service section 2010 provides a chat service to the image forming apparatus 10 or the terminal device 30. For example, the image forming apparatus 10 or the terminal device 30 can use a chat service by displaying a chat screen via a web browser or a chat application.

Here, the chat screen is a display screen displayed on the image forming apparatus 10 or the terminal device 30 as a user interface for inputting question sentences and outputting answer sentences.

The chat service section 2010 displays a chat screen on the image forming apparatus 10 or the terminal device 30, and accepts input of question sentences from the chat screen. The chat service section 2010 transmits answer sentences corresponding to question sentences to the image forming apparatus 10 or the terminal device 30. A device on which the chat screen is displayed displays the chat and can display answer sentences from the chat.

The session information generator 2020 generates session information in response to a request from the image forming apparatus 10. The session information generator 2020 may generate unique session information in the order of requests, or may generate session information from information such as model information or a serial number of the image forming apparatus 10.

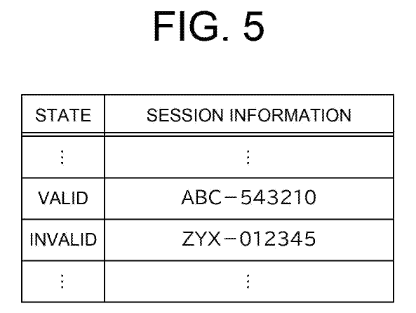

The storage section 210 of the server device 20 secures a management information storage area 2110 for storing management information. The management information is information managed by the server device 20 for verifying session information transmitted from the image forming apparatus 10 or the terminal device 30. Here, an example of management information stored in the management information storage area 2110 will be described with reference to FIG. 5. The management information stores a state (for example, "valid") and session information (for example, "ABC-543210"). Here, the state is, for example, information indicating whether session information is "valid" or "invalid".

In order for a user to use a chat service via the image forming apparatus 10 or the terminal device 30, session information is required. Since session information is information that changes each time a chat service is used, it is desirable that session information be generated immediately before use of the chat service. Session information is generated by the image forming apparatus 10 communicating with the server device 20 side providing the chat service immediately before use of the chat service. Then, the generated session information is managed by the server device 20.

### 1.4 Flow of Processing

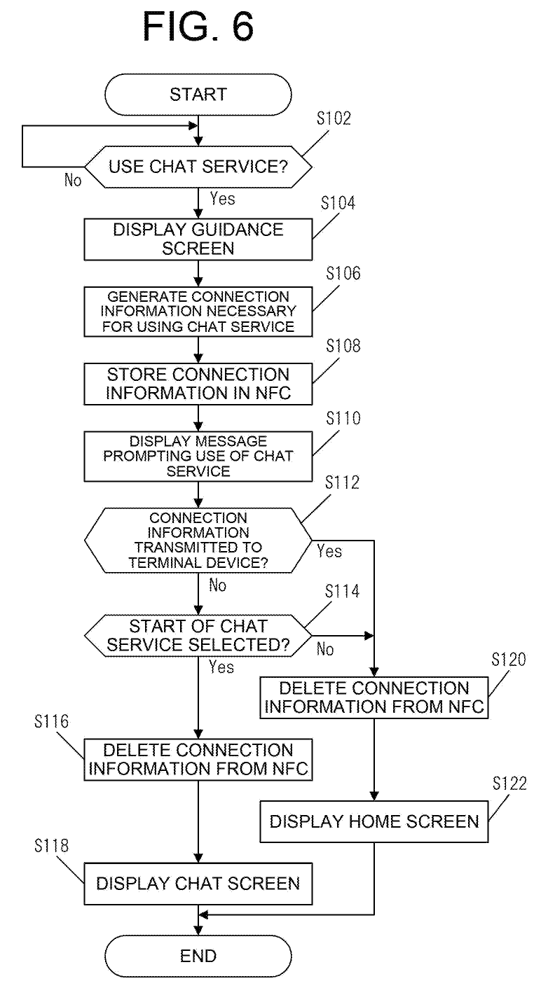

A flow of processing in the present embodiment will be described below. FIGS. 6 to 8 are diagrams showing the flow of processing of the system 1 in the present embodiment.

Note that the following processing will be described as being executed by the one or more controllers (controller 100, controller 200, controller 300) of each device (image forming apparatus 10, server device 20, terminal device 30), but each configuration described in FIGS. 4A and 4B may execute processing of each step.

### 1.4.1 Main Processing

FIG. 6 is a diagram showing the flow of main processing executed by the image forming apparatus 10.

First, the one or more controllers 100 determine whether an operation for using a chat service has been performed by a user (S102). When there is an operation for using a chat service from a user, the one or more controllers 100 display a guidance screen on the display device 140 (S102; Yes -> S104).

On the other hand, when the one or more controllers 100 determine that there was no operation for using a chat service, the one or more controllers 100 repeat determination of whether an operation for using a chat service has been performed (S102; No -> S102).

Determination of whether an operation for using a chat service has been performed by a user is made based on, for example, whether an "AI assistant function" button displayed on a display screen such as a home screen has been selected.

Here, a guidance screen refers to a display screen for guiding a connection to a chat service, the display screen being capable of selecting which of the image forming apparatus 10 or the terminal device 30 is to be used for using the chat service. The guidance screen may include a message for guiding a connection to a chat service.

Next, the one or more controllers 100 acquire session information from the server device 20 and generate connection information as information necessary for using the chat service (S106). Here, information necessary for using a chat service is information including session information for the image forming apparatus 10 or the terminal device 30 to connect to the server device 20 and use the chat service.

In the present embodiment, the image forming apparatus 10 generates information necessary for using a chat service as connection information, but information necessary for using a chat service does not have to be connection information. Information necessary for using a chat service may be, for example, information including model information of the image forming apparatus 10, a state of the device, user operation information, etc.

Subsequently, the one or more controllers 100 store connection information in the connection information storage area 1810 of the short-range wireless communicator 180 (S108).

Next, the one or more controllers 100 display a message prompting use of the chat service on the display device 140 (S110). Here, a message prompting use of a chat service refers to a message prompting an operation for displaying a chat screen on either the image forming apparatus 10 or the terminal device 30 and guiding a connection to the chat service.

Subsequently, the one or more controllers 100 determine whether connection information has been transmitted to the terminal device 30 (S112). As a method for determining whether connection information has been transmitted, for example, it may be determined that connection information has been transmitted when short-range wireless communication with the terminal device 30 is performed via the short-range wireless communicator 180.

When connection information has not been transmitted to the terminal device, the one or more controllers 100 determine whether start of a chat service has been selected (S112; No -> S114). For example, when an operation for transitioning from a guidance screen to a chat screen is performed on the image forming apparatus 10 on the guidance screen, it may be determined that start of the chat service has been selected.

Note that on a guidance screen, when a predetermined time has elapsed without any operation, it may be determined that start of a chat service was not selected. Further, on a guidance screen, when a user performs a cancellation operation of using a chat service or an operation for transitioning to a home screen, it may be determined that start of a chat service was not selected.

When start of a chat service is selected, the one or more controllers 100 delete connection information from the connection information storage area 1810 of the short-range wireless communicator 180, display a chat screen on the display device 140, and start the chat service in the image forming apparatus 10 (S114; Yes -> S116 -> S118).

When start of a chat service is not selected, the one or more controllers 100 delete connection information from the connection information storage area 1810 of the short-range wireless communicator 180 and display a home screen on the display device 140 (S114; No -> S120 -> S122).

On the other hand, when connection information is transmitted to the terminal device 30, the one or more controllers 100 delete connection information from the connection information storage area 1810 of the short-range wireless communicator 180 and display a home screen on the display device 140. In this case, the chat service is started in the terminal device 30 (S112; Yes -> S120 -> S122).

### 1.4.2 Use of Chat Service from Terminal Device

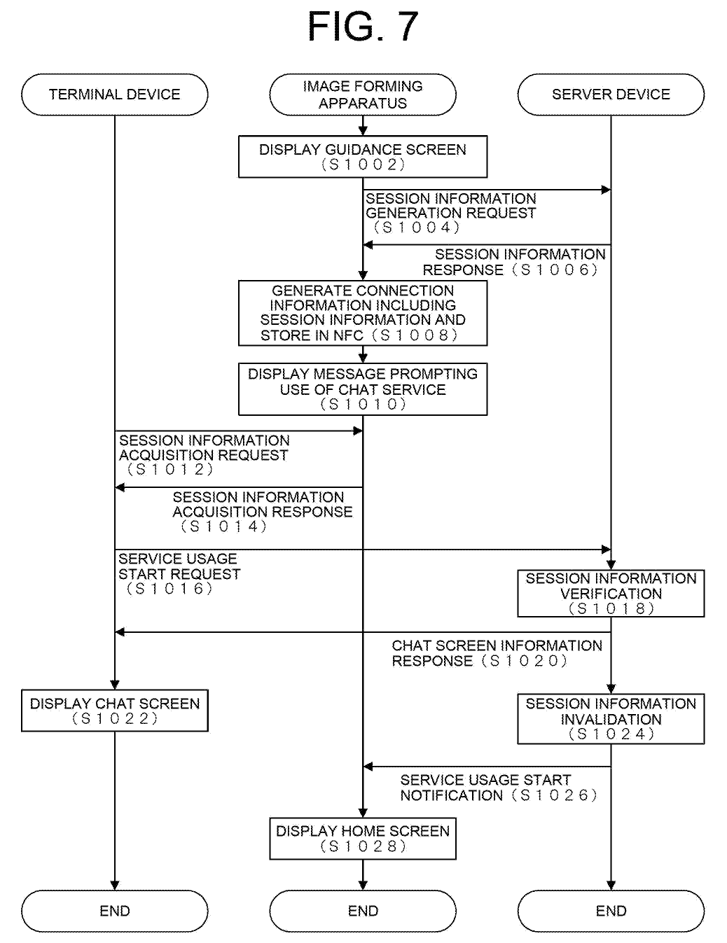

FIG. 7 is a diagram showing the flow of terminal device chat service usage processing for starting a chat service on an operation screen of the terminal device 30 using connection information for connecting to the server device 20 acquired from the image forming apparatus 10 via NFC. First, the image forming apparatus 10 displays a guidance screen on the display device 140 (S1002).

Next, the image forming apparatus 10 transmits a session information generation request to the server device 20 (S1004). When receiving the session information generation request, the server device 20 generates session information in response to the session information generation request and transmits a session information response including the session information to the image forming apparatus 10 (S1006).

The image forming apparatus 10 receiving session information generates connection information including the session information and stores the connection information in the connection information storage area 1810 of the short-range wireless communicator 180 (NFC) (S1008).

Next, the image forming apparatus 10 displays a message prompting use of the chat service on the display device 140 (S1010).

The terminal device 30 transmits a session information acquisition request to the image forming apparatus 10 via short-range wireless communication by the short-range wireless communicator 180 (S1012).

The image forming apparatus 10 receiving the session information acquisition request transmits a session information acquisition response including the session information to the terminal device 30 via short-range wireless communication by the short-range wireless communicator 180 (S1014).

Next, the terminal device 30 receiving the session information transmits a service usage start request including the received session information to the server device 20 (S1016).

The server device 20 receiving the service usage start request executes session information verification processing for comparing session information included in the service usage start request with session information corresponding to management information stored by the server device 20 and verifying whether session information is valid (S1018).

When session information can be verified as valid, the server device 20 transmits a chat screen information response including display data of a chat screen to the terminal device 30 (S1020).

The terminal device 30 displays data of a chat screen included in the received chat screen information response on the display device 340 (S1022). In this way, the chat service in the terminal device 30 is started.

On the other hand, the server device 20 executes session information invalidation processing for invalidating the session information verified in the session information verification processing of S1018 after transmitting the chat screen information response (S1024).

Next, the server device 20 transmits a service usage start notification to the image forming apparatus 10 after executing the session information invalidation processing (S1026).

The image forming apparatus 10 receiving the service usage start notification displays a home screen (S1028).

In S1028, the image forming apparatus 10 may display an operation screen that was displayed when a calling instruction of the "AI assistant function" was made, instead of the home screen. That is, the image forming apparatus 10 displays a home screen when the "AI assistant function" is called from the home screen, and may display a job screen when the "AI assistant function" is called from a job screen such as a copy screen. The image forming apparatus 10 can display an operation screen (home screen, job screen, etc.) capable of accepting an operation on the display device 140 after transmitting connection information to the terminal device 30 via the short-range wireless communicator 180.

Note that the server device 20 may end provision of the chat service by ending a browser or a chat application of the terminal device 30.

The above operation flow is an example, and partially different processing may be performed. In the present embodiment, for example, the image forming apparatus 10 displays a home screen at a timing when a chat service in the terminal device 30 is started, but may display a home screen at a different timing. For example, the image forming apparatus 10 may display a home screen on the display device 140 after transmitting a session information acquisition response to the terminal device 30.

### 1.4.3 Use of Chat Service from Image Forming Apparatus

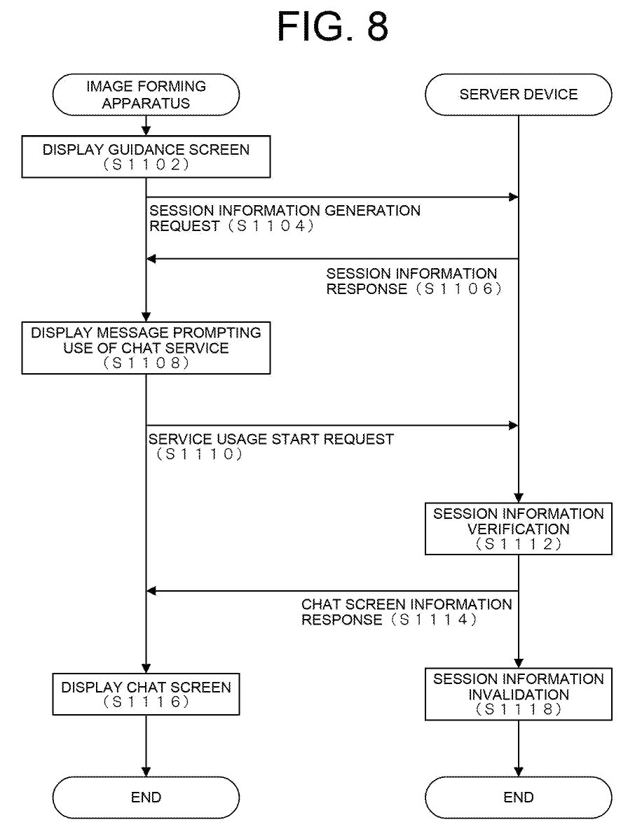

FIG. 8 is a diagram showing the flow of image forming apparatus chat service usage processing for starting a chat service on an operation screen of the image forming apparatus 10.

First, the image forming apparatus 10 displays a guidance screen on the display device 140 (S1102). Next, the image forming apparatus 10 transmits a session information generation request to the server device 20 similarly to S1004 (S1104). Then, the server device 20 receiving the session information generation request transmits a session information response to the image forming apparatus 10 similarly to S1006 (S1106). The image forming apparatus 10 receiving the session information response displays a message prompting use of the chat service on the display device 140 similarly to S1010 (S1108).

Here, when a user selects use of a chat service in the image forming apparatus 10, the image forming apparatus 10 transmits a service usage start request to the server device 20 (S1110). Here, session information is included in a service usage start request transmitted from the image forming apparatus 10 similarly to S1016.

The server device 20 receiving the service usage start request executes session information verification processing similarly to S1018 (S1112). When session information can be verified as valid, the server device 20 transmits a chat screen information response including display data of a chat screen to the image forming apparatus 10 (S1114).

The image forming apparatus 10 receiving a chat screen information response displays data of a chat screen included in the chat screen information response on the display device 140 (S1116). In this way, the chat service in the image forming apparatus 10 is started. On the other hand, the server device 20 executes session information invalidation processing similarly to S1024 (S1118).

Note that the server device 20 may end provision of the chat service by a user selecting a display button such as a home key and displaying a home screen on the display device 140 of the image forming apparatus 10.

### 1.5 Operation Example

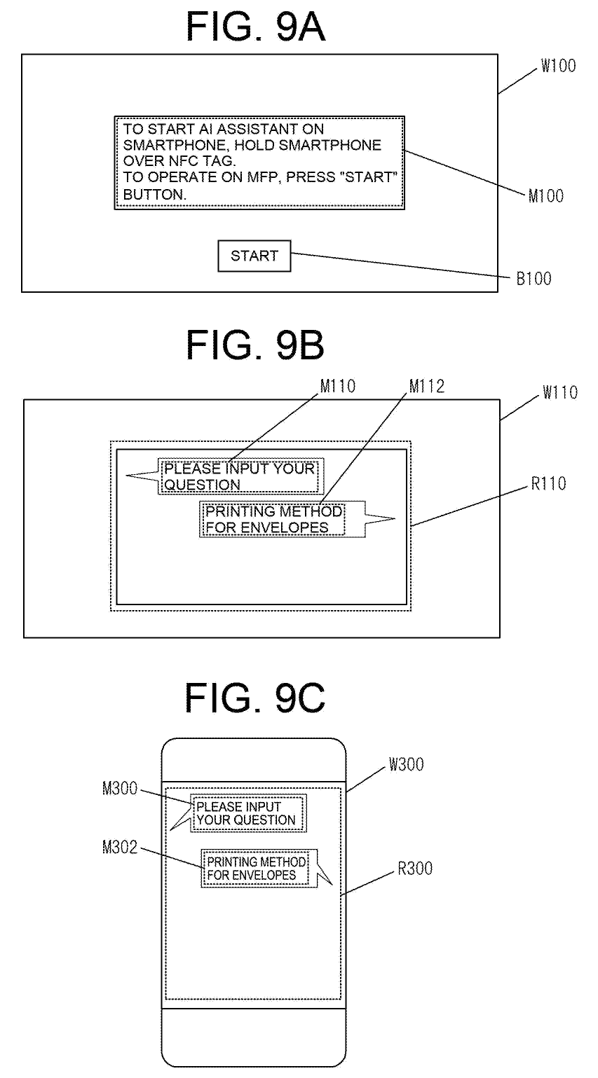

FIGS. 9A, 9B, and 9C are diagrams showing examples of a display screen including a message displayed to a user as operation results of the image forming apparatus 10 and the terminal device 30 in the present embodiment.

FIG. 9A is a diagram showing an example of a display screen W100 displayed on the display device 140 of the image forming apparatus 10 after a user instructs activation of the function by selecting an "AI assistant function" button displayed on a home screen as a selection for using a chat service.

On the display screen W100, a message M100 prompting use of a chat service is displayed, stating "When starting AI assistant with a smartphone, hold the smartphone over the NFC tag. When operating with MFP, press 'Start' button." and further, on the display screen W100, a display button (start button) B100 is displayed as a display for starting use of the chat service and transitioning the screen to a chat screen. That is, the display screen W100 is a guidance screen on which a message for guiding use of a chat service is displayed to a user.

Here, when a user selects the display button B100, the one or more controllers 100 display a display screen W110. On the other hand, when a user holds the terminal device 30 over the short-range wireless communicator 180 (NFC tag), the terminal device 30 displays a display screen W300 on the display device 340. The one or more controllers 100 end display of a guidance screen and displays, for example, a home screen.

FIG. 9B is a diagram showing an example of a display screen W110 displayed on the display device 140 of the image forming apparatus 10 when a user selects the display button B100.

A chat service display area R110 is secured on the display screen W110. In the chat service display area R110, a message M110 for notifying a user received from the server device 20 stating "Please input your question" and a message M112 "Printing method for envelopes" as a question sentence from the user are displayed. That is, the display screen W110 is a chat screen where a chat service is provided.

FIG. 9C is a diagram showing an example of a display screen W300 displayed on the display device 340 of the terminal device 30 when a user holds the terminal device 30 over the short-range wireless communicator 180.

A chat service display area R300 is secured on the display screen W300. In the chat service display area R300, a message M300 for notifying a user received from the server device 20 stating "Please input your question" and a message M302 "Printing method for envelopes" as a question sentence from the user are displayed. That is, the display screen W300 is a chat screen where a chat service is provided.

In this way, in addition to use of a chat service in the terminal device 30 utilizing the short-range wireless communicator 180, use of a chat service in an operation screen of the image forming apparatus 10 also becomes possible.

Note that when a chat service is used on an operation screen of the image forming apparatus 10, use of the chat service on an operation screen of the terminal device 30 of the user can be made impossible.

Specifically, since the image forming apparatus 10 clears connection information written in the connection information storage area 1810 of the short-range wireless communicator 180, use of the chat service in the terminal device 30 is not started even if the terminal device 30 is held over the short-range wireless communicator 180 (NFC).

Alternatively, when the terminal device 30 is held over the short-range wireless communicator 180, connection information is transmitted to the server device 20. Here, session information included in connection information is session information that has been already used for use of a chat service in the image forming apparatus 10 and has been invalidated. Therefore, session information is determined to be invalid in the server device 20, a session cannot be established, and use of the chat service in the terminal device 30 is not started.

When use of a chat service is started in any one terminal device 30 among a plurality of terminal devices 30, use of the chat service in the image forming apparatus 10 and other terminal devices 30 can be made impossible.

Specifically, when use of a chat service is started in any one terminal device 30, use of the chat service in the image forming apparatus 10 and other terminal devices 30 can be made impossible by performing control for clearing connection information from the short-range wireless communicator 180 and transitioning a display screen of the image forming apparatus 10 from a guidance screen to a home screen or the like. After a display screen of the image forming apparatus 10 transitions to a home screen or the like, even if other terminal devices 30 are held over the short-range wireless communicator 180, use of the chat service in the other terminal devices 30 is not started because connection information is cleared from the short-range wireless communicator 180. Further, even if an activation instruction of "AI assistant function" is made after transitioning to a home screen or the like, use of the chat service in the image forming apparatus 10 and other terminal devices 30 can be made impossible by not accepting the activation instruction until an end notification of a previous session is received from the server device.

Note that when a display screen of the image forming apparatus 10 transitions from a guidance screen to a home screen or the like, normal use of the image forming apparatus 10 excluding "AI assistant function" becomes possible. Thereby, even during use of a chat service in the terminal device 30, influence on users using the image forming apparatus 10 can be suppressed.

### 1.6 Effects, etc.

In this way, it becomes possible to provide an information processing apparatus or the like capable of appropriately providing a usage screen of a chat service desired by a user.

In response to an activation instruction of "AI assistant function" from a user, after displaying a guidance screen for selecting which of the image forming apparatus 10 or the terminal device 30 is to be used for a chat service, when use of the chat service in the image forming apparatus 10 is selected, an operation screen of the image forming apparatus 10 can be transitioned to a chat screen. On the other hand, when use of a chat service in the terminal device 30 is selected, connection information necessary for using the chat service can be transmitted to the terminal device 30 and a chat screen can be displayed on the display device 340 of the terminal device 30.

Thereby, when checking an operation method or the like of the image forming apparatus 10 by interacting with the server device 20 in an interactive manner utilizing a chat service, use of the chat service becomes possible in a device desired by a user among the image forming apparatus 10 or the terminal device 30 possessed by the user.

### 2 Second Embodiment

A second embodiment will be described below. The second embodiment is an embodiment for displaying a two-dimensional code on a guidance screen.

In the second embodiment, description will be omitted for parts where configurations of hardware and software are same as those in the first embodiment, and points different from the first embodiment will be mainly described.

### 2.1 Software Configuration

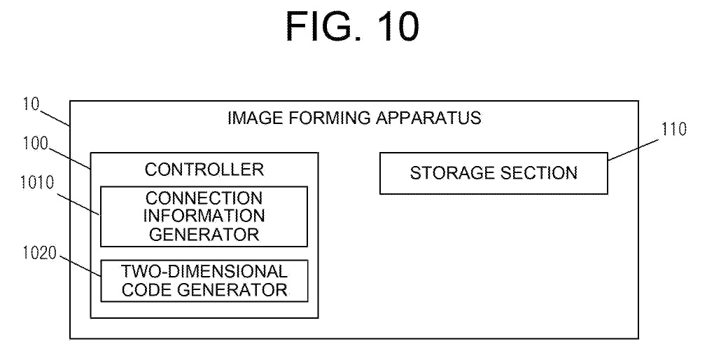

FIG. 10 is a diagram showing the configuration of software of the image forming apparatus 10.

### 2.1.1 Image Forming Apparatus

Configuration of main software of the image forming apparatus 10 will be described. For example, the one or more controllers 100 can realize a two-dimensional code generator 1020 by reading and executing programs stored in the storage section 110 (storage 112, ROM 114).

The two-dimensional code generator 1020 generates, as encoded information, for example, a two-dimensional code based on connection information.

Here, encoded information may be a graphic or a character string (here, a character string is a character string of one or more characters. Further, a character includes one or plurality of numbers, English characters, kana, hiragana, kanji, symbols, etc.). When encoded information is a graphic, it may be a one-dimensional code such as a barcode (for example, EAN code, JAN code, Cobabar, CODE128, etc.), or may be a two-dimensional code. As a two-dimensional code, it may be a stack type two-dimensional code (for example, PDF417, CODE49, etc.), or may be a matrix type two-dimensional code (for example, Quick Response code (QR code (registered trademark)), DataMatrix, VeriCode, Aztec, etc.). Hereinafter, in the present embodiment, a Quick Response code (QR code) will be described as an example.

### 2.2 Flow of Processing

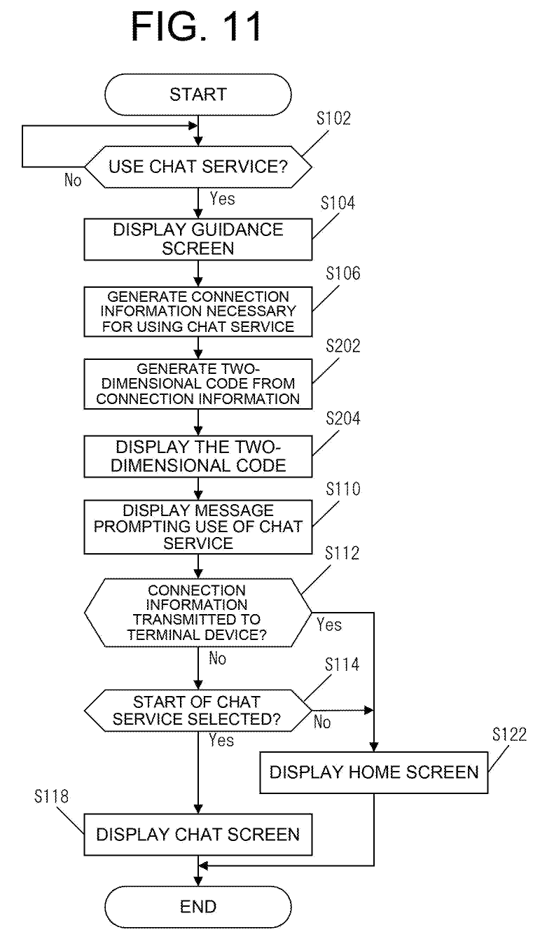

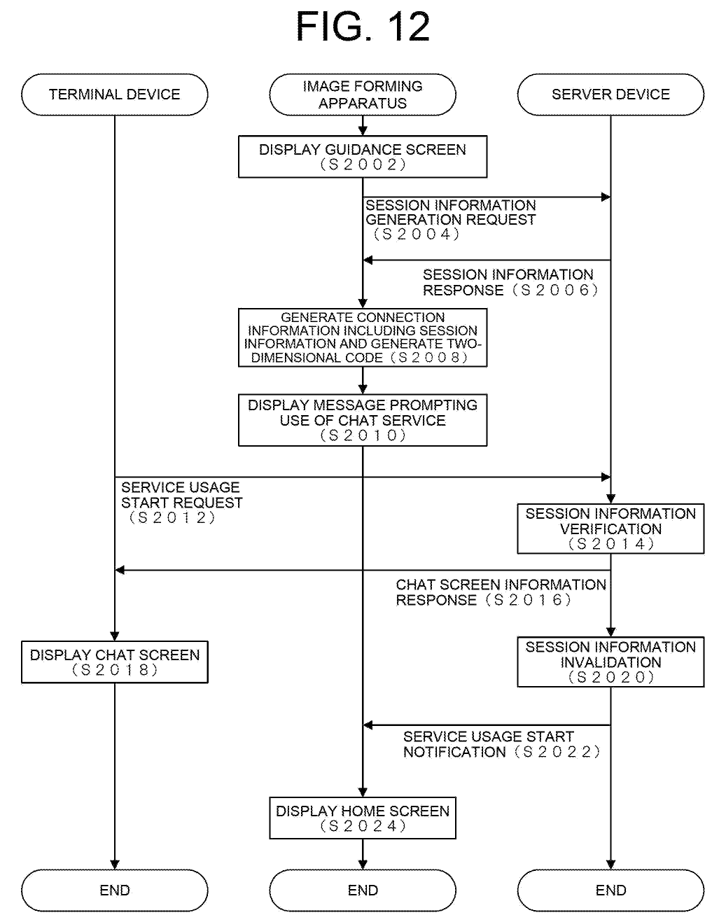

A flow of processing in the present embodiment will be described below. FIGS. 11 and 12 are diagrams showing the flow of processing of the system 1 in the present embodiment.

### 2.2.1 Main Processing Flow

FIG. 11 is a diagram showing the flow of main processing executed by the image forming apparatus 10. FIG. 11 replaces FIG. 6 of the first embodiment, and S202 and S204 are executed between S106 and S110.

The one or more controllers 100 generate a two-dimensional code from connection information (S202). Subsequently, the one or more controllers 100 display the two-dimensional code generated in S202 on a guidance screen along with a message prompting chat use (S204 -> S110).

### 2.2.2 Use of Chat Service from Terminal Device

FIG. 12 is a diagram showing the flow of terminal device chat usage processing for starting a chat service on an operation screen of the terminal device 30 using connection information for connecting to the server device 20 acquired from the image forming apparatus 10 via a two-dimensional code.

First, the image forming apparatus 10 displays a guidance screen on the display device 140 (S2002). Next, the image forming apparatus 10 transmits a session information generation request to the server device 20 similarly to S1004 (S2004).

When receiving a session information generation request, the server device 20 transmits a session information response to the image forming apparatus 10 similarly to S1006 (S2006). Subsequently, the image forming apparatus 10 receiving session information generates connection information including session information, and generates a two-dimensional code based on the connection information (S2008).

Next, the image forming apparatus 10 displays a message prompting use of the chat service on the display device 140 (S2010).

Next, the terminal device 30 transmits a service usage start request including session information acquired via a two-dimensional code to the server device 20 (S2012).

When receiving a service usage start request, the server device 20 executes session information verification processing similarly to S1018 (S2014). Next, the server device 20 transmits a chat screen information response to the terminal device 30 similarly to S1020 (S2016).

When receiving a chat screen information response, the terminal device 30 displays a chat screen similarly to S1022 (S2018). The server device 20 executes session information invalidation processing similarly to S1024 (S2020), and subsequently transmits a service usage start notification to the image forming apparatus 10 (S2022).

When receiving a service usage start notification, the image forming apparatus 10 displays a home screen on the display device 140 because a chat service has been started in the terminal device 30 (S2024).

The above operation flow is an example, and partially different processing may be performed. In the present embodiment, for example, a service usage start notification is transmitted to the image forming apparatus 10, but may not be transmitted. For example, a home screen may be displayed when a predetermined time has elapsed or when cancellation is selected by an operation by a user.

### 2.3 Operation Example

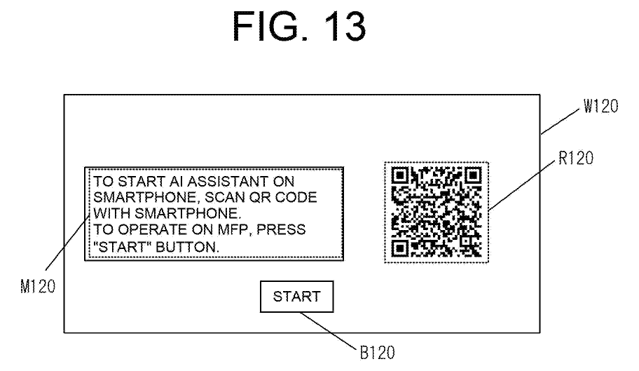

FIG. 13 is a diagram showing an example of a display screen including a message displayed to a user as an operation result of the image forming apparatus 10 in the present embodiment.

FIG. 13 is a diagram showing an example of a display screen W120 displayed on the display device 140 of the image forming apparatus 10 after a user instructs activation of the function by selecting an "AI assistant function" button displayed on a home screen as a selection for using a chat service.

On the display screen W120, a message M120 prompting use of a chat service is displayed, stating "When starting AI assistant with a smartphone, read the QR code with a smartphone. When operating with MFP, press 'Start' button." and further, on the display screen W120, a display button B120 is displayed as a display for starting use of the chat service and transitioning the screen to a chat screen. That is, the display screen W120 is a guidance screen on which a message for guiding use of a chat service is displayed to a user.

Here, when a user selects the display button B120, the one or more controllers 100 display a display screen W110. On the other hand, when a user reads a two-dimensional code using a camera application (photographing section 390) of the terminal device 30, the terminal device 30 displays a display screen W300 on the display device 340. The one or more controllers 100 end display of a guidance screen and displays, for example, a home screen.

In this way, in addition to use of a chat service in the terminal device 30 utilizing a two-dimensional code, use of a chat service in an operation screen of the image forming apparatus 10 also becomes possible.

Note that when a chat service is used on an operation screen of the image forming apparatus 10, use of the chat service in the terminal device 30 becomes impossible because a two-dimensional code cannot be displayed on the display device 140.

When use of a chat service is started in any one terminal device 30 among a plurality of terminal devices 30, use of the chat service in the image forming apparatus 10 and other terminal devices 30 can be made impossible.

Specifically, when use of a chat service is started in any one terminal device 30, use of the chat service in the image forming apparatus 10 and other terminal devices 30 can be made impossible by transitioning a display screen of the image forming apparatus 10 from a guidance screen to a screen not including display of a two-dimensional code, such as a home screen. Further, even if an activation instruction of "AI assistant function" is made after a display screen of the image forming apparatus 10 transitions to a home screen or the like, use of the chat service in the image forming apparatus 10 and other terminal devices 30 can be made impossible by not accepting the activation instruction until an end notification of a previous session is received from the server device.

Note that when a display screen of the image forming apparatus 10 transitions from a guidance screen to a home screen or the like, functions of the image forming apparatus 10 excluding "AI assistant function" become usable. Thereby, even during use of a chat service in the terminal device 30, influence on users using the image forming apparatus 10 can be suppressed.

### 3 Third Embodiment

A third embodiment will be described below. The third embodiment is an embodiment for displaying an error screen on the image forming apparatus 10 or the terminal device 30 when session information is invalid.

In the third embodiment, description will be omitted for parts where configurations of hardware and software are same as those in the first embodiment, and points different from the first embodiment will be mainly described.

### 3.1 Flow of Processing

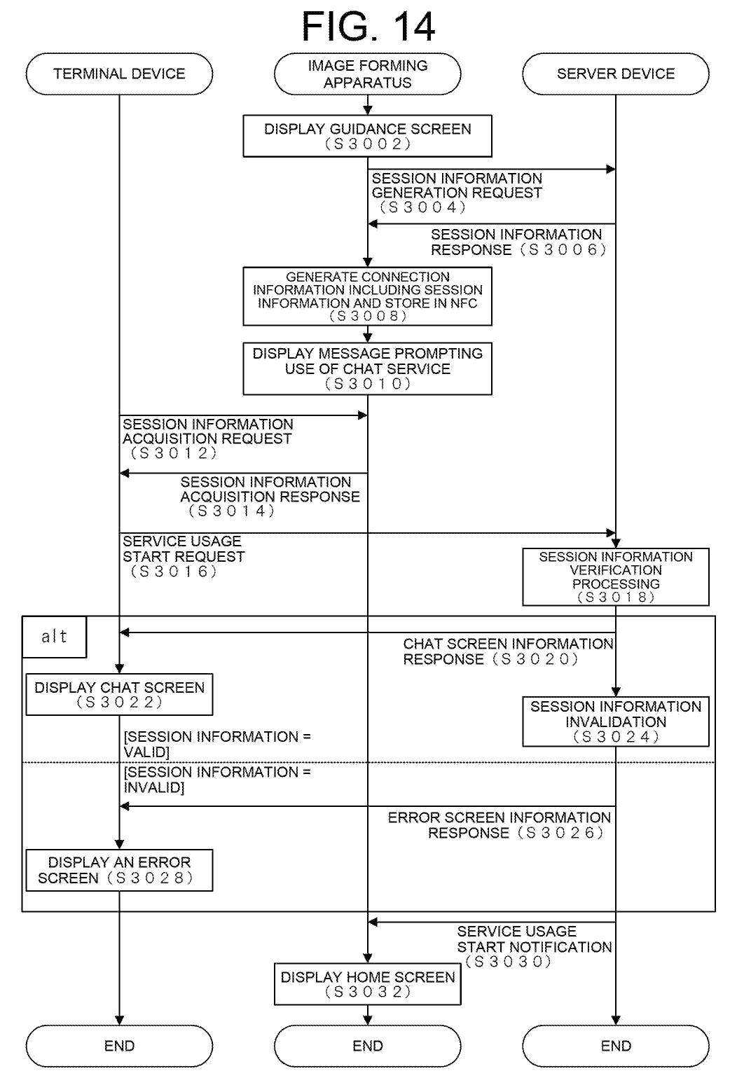

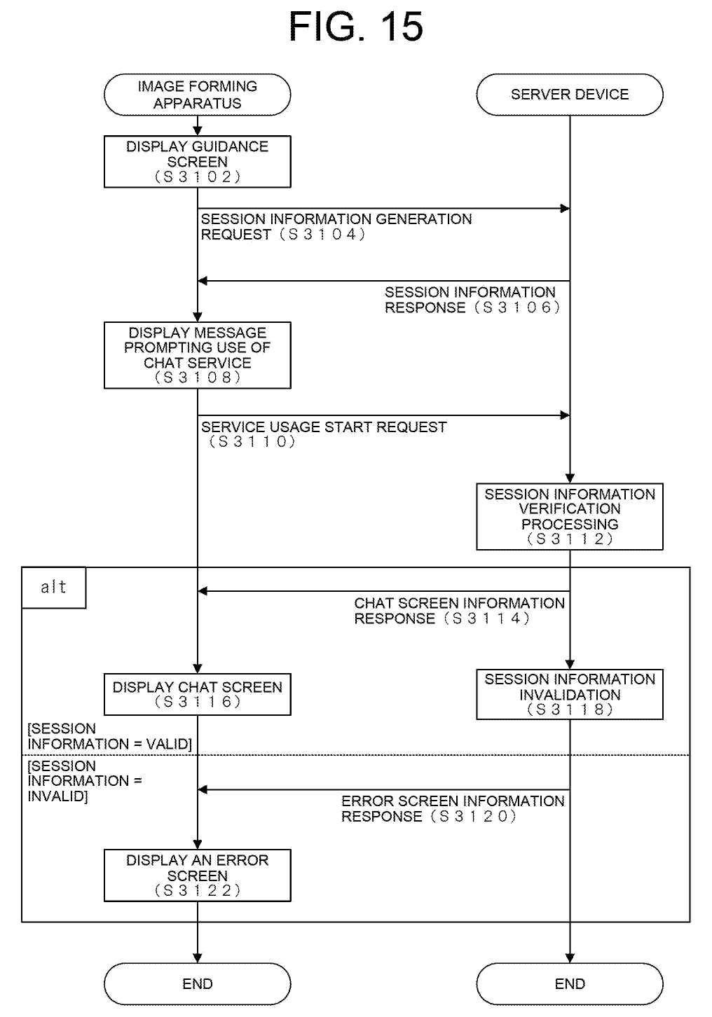

A flow of processing in the present embodiment will be described below. FIGS. 14 and 15 are diagrams showing the flow of processing of the system 1 in the present embodiment.

### 3.1.1 Use of Chat Service from Terminal Device

FIG. 14 is a diagram showing the flow of terminal device chat service usage processing for starting a chat service on an operation screen of the terminal device 30 using connection information for connecting to the server device 20 acquired from the image forming apparatus 10 via NFC.

First, the image forming apparatus 10 displays a guidance screen on the display device 140 (S3002). Next, the image forming apparatus 10 transmits a session information generation request to the server device 20 similarly to S1004 (S3004).

The server device 20 receiving a session information generation request transmits a session information response to the image forming apparatus 10 similarly to S1006 (S3006). Subsequently, the image forming apparatus 10 receiving a session information response generates connection information including session information, and stores the connection information in the connection information storage area 1810 of the short-range wireless communicator 180 (NFC) (S3008).

Next, the image forming apparatus 10 displays a message prompting use of the chat service on the display device 140 similarly to S1010 (S3010).

The terminal device 30 transmits a session information acquisition request to the image forming apparatus 10 similarly to S1012 (S3012). The image forming apparatus 10 receiving a session information acquisition request transmits a session information acquisition response to the terminal device 30 similarly to S1014 (S3014).

Next, the terminal device 30 receiving session information transmits a service usage start request to the server device 20 similarly to S1016 (S3016). The server device 20 receiving a service usage start request executes session information verification processing similarly to S1018 (S3018).

Here, when the server device 20 can verify that session information included in a received service usage start request is valid, the server device 20 transmits a chat screen information response to the terminal device 30 similarly to S1020 (S3018; session information = valid -> S3020). Subsequently, the terminal device 30 receiving a chat screen information response displays a chat screen on the display device 340 similarly to S1022 (S3022).

Further, the server device 20 executes session information invalidation processing similarly to S1024 (S3024).

On the other hand, when the server device 20 can verify that session information included in a received service usage start request is invalid, the server device 20 transmits an error screen information response including information of an error screen to the terminal device 30 (S3018; session information = invalid -> S3026). Subsequently, the terminal device 30 displays an error screen on the display device 340 of the terminal device 30 based on information of an error screen included in a received error screen information response (S3028).

Here, an error screen refers to a display screen including a message notifying a user that session information is invalid without transitioning to a chat screen.

Then, the server device 20 transmits a service usage start notification to the image forming apparatus 10 after executing session information invalidation processing (S3030).

Next, the image forming apparatus 10 receiving a service usage start notification displays a home screen similarly to S1028 (S3032).

Note that the above operation flow is an example, and partially different processing may be performed. In the present embodiment, for example, an error screen is displayed on the display device 340 of the terminal device 30, but in processing of S3026, an error screen information response may be transmitted to the image forming apparatus 10 and an error screen may be displayed on the display device 140 of the image forming apparatus 10. Further, the image forming apparatus 10 receiving an error notification from the server device 20 may provide error screen information to the terminal device 30 and cause the terminal device 30 to display an error screen.

### 3.1.2 Use of Chat Service from Image Forming Apparatus

FIG. 15 is a diagram showing the flow of image forming apparatus chat service usage processing for starting a chat service on an operation screen of the image forming apparatus 10.

First, the image forming apparatus 10 displays a guidance screen on the display device 140 (S3102). Next, the image forming apparatus 10 transmits a session information generation request to the server device 20 similarly to S1104 (S3104). Then, the server device 20 receiving a session information generation request transmits a session information response to the image forming apparatus 10 similarly to S1106 (S3106). The image forming apparatus 10 receiving a session information response displays a message prompting use of the chat service on the display device 140 similarly to S1108 (S3108).

Here, when a user selects use of a chat service in the image forming apparatus 10, the image forming apparatus 10 transmits a service usage start request to the server device 20 similarly to S1110 (S3110). The server device 20 receiving a service usage start request executes session information verification processing similarly to S1112 (S3112).

Here, when the server device 20 can verify that session information is valid, the server device 20 transmits a chat screen information response to the image forming apparatus 10 similarly to S1114 (S3112; session information = valid -> S3114). Subsequently, the image forming apparatus 10 receiving a chat screen information response displays a chat screen on the display device 140 similarly to S1116 (S3116).

Further, the server device 20 executes session information invalidation processing similarly to S1118 (S3118).

On the other hand, when the server device 20 can verify that session information is invalid, the server device 20 transmits an error screen information response including information of an error screen to the image forming apparatus 10 (S3112; session information = invalid -> S3120).

Subsequently, the image forming apparatus 10 receiving an error screen information response displays an error screen on the display device 140 of the image forming apparatus 10 based on information of an error screen included in an error screen information response (S3122).

### 3.2 Operation Example

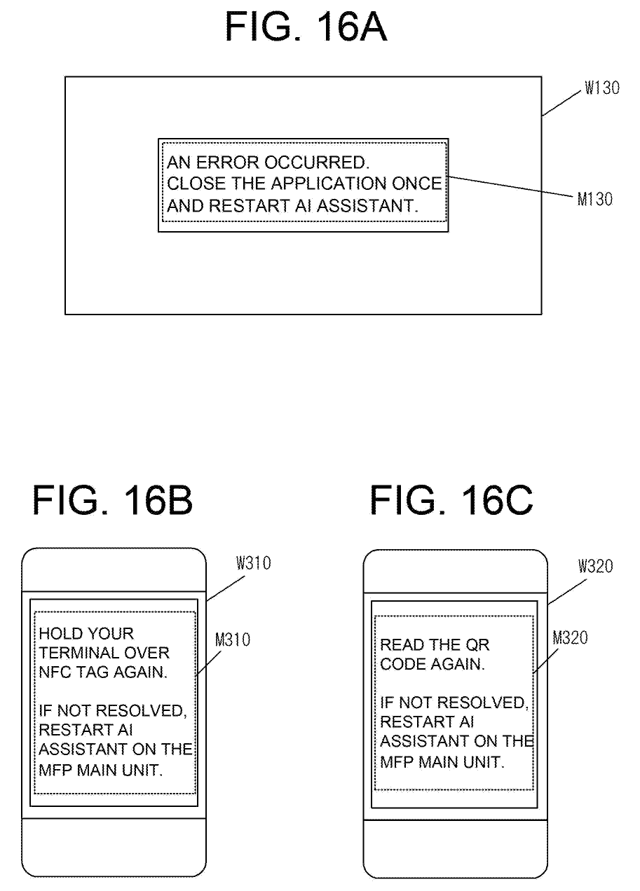

FIGS. 16A, 16B, and 16C are diagrams showing examples of a display screen including a message displayed to a user as operation results of the image forming apparatus 10 and the terminal device 30 in the present embodiment.

FIG. 16A is a diagram showing an example of a display screen W130 displayed on the display device 140 of the image forming apparatus 10 when a display button B100 is selected in the display screen W100 of FIG. 9A, or when a display button B120 is selected in the display screen W120 of FIG. 13.

On the display screen W130, a message M130 for notifying a user of an error received from the server device 20 is displayed, stating "An error occurred. Close the application once and restart AI assistant.". That is, the display screen W130 is an error screen on which a message for notifying a user of an error is displayed.

Here, when a user performs an operation for transitioning to a home screen on the display screen W130, or when a predetermined time has elapsed after display of the display screen W130, the one or more controllers 100 ends display of the error screen and displays, for example, a home screen.

FIG. 16B is a diagram showing an example of a display screen W310 displayed on the display device 340 of the terminal device 30 when the terminal device 30 acquires connection information including invalidated session information from the short-range wireless communicator 180 by short-range wireless communication and attempts to start using a chat service.

On the display screen W310, a message M310 for notifying a user of an error received from the server device 20 is displayed, stating "Hold your terminal over the NFC tag again. If not resolved, restart AI assistant on the MFP main unit.". That is, the display screen W310 is an error screen on which a message for notifying a user of an error is displayed.

FIG. 16C is a diagram showing an example of a display screen W320 displayed on the display device 340 of the terminal device 30 when use of a chat service is attempted to be started by reading a two-dimensional code generated based on connection information including session information already invalidated in the terminal device 30.

On the display screen W320, a message M320 for notifying a user of an error received from the server device 20 is displayed, stating "Read the QR code again. If not resolved, restart AI assistant on the MFP main unit.". That is, the display screen W320 is an error screen on which a message for notifying a user of an error is displayed.

In this way, even if use of a chat service is attempted to be started utilizing connection information including invalidated session information, it is determined to be invalid by session information verification processing on the server device 20 side and an error occurs, and an error screen can be displayed without transitioning a display screen of the image forming apparatus 10 or the terminal device 30 to a chat screen.

### 4 Modifications

The present disclosure is not limited to the above embodiments, and various changes are possible.

That is, embodiments obtained by combining technical means appropriately changed within a range not departing from the gist of the present disclosure are also included in the technical scope.

Further, although the above embodiments have been described separately for convenience of description, they can be executed in combination as much as possible. Further, for any of the techniques described in the specification, there is an intention to obtain rights by correction or a divisional application, etc.

Further, programs operating in each device in each embodiment are programs controlling a CPU, etc. so as to realize functions of the above embodiments (programs causing a computer to function). Then, information handled in these devices is temporarily stored in a temporary storage device (for example, RAM) at a time of processing, and thereafter stored in storage devices of various ROMs or HDDs, and read out, corrected, or written by the CPU as necessary.

Here, as a recording medium for storing programs, any of semiconductor media (for example, ROM, non-volatile memory card, etc.), optical recording media/magneto-optical recording media (for example, DVD (Digital Versatile Disc), CD (Compact Disc), BD (Blu-ray (registered trademark) Disc), etc.), magnetic recording media (for example, magnetic tape, flexible disk, etc.), etc. may be used.

Further, in a case of distributing to a market, programs can be stored and distributed in a portable recording medium, or transferred to a server computer connected via a network such as the Internet. In this case, of course, a storage device of the server device is also included in the present disclosure.

Note that the above data is not stored in a device, but may be stored in an external device and called appropriately. For example, data may be stored in a NAS (Network Attached Storage) or stored on a cloud.

Note that the scope of the present disclosure is not limited to configurations explicitly described in the specification, but includes combinations of techniques disclosed in the specification. Among the present disclosure, configurations for which a patent is sought are described in the attached claims, but there is no intention to exclude them from the technical scope for a reason that they are not described in the claims.

Further, in the above specification, descriptions of "in a case of" and "when" are described as one example, and are not configurations limited to described contents. Even for configurations not in these cases or times, ranges obvious to those skilled in the art are also disclosed, and there is an intention to obtain rights.

Further, for processing described in the specification and descriptions of data flow involving order, the order is not limited to described order. For example, configurations in which a part of processing is deleted or order is changed are also disclosed, and there is an intention to obtain rights.

Further, although it has been described that functions described in the embodiments are executed by each device, they may be realized by one device, or an external server may be further utilized.

Further, each functional block or various features of devices used in the above embodiments may be implemented or executed by an electrical circuit, for example, an integrated circuit or a plurality of integrated circuits. Electrical circuits designed to execute functions described in the specification may include a general purpose processor, a digital signal processor (DSP), an application specific integrated circuit (ASIC), a field programmable gate array (FPGA), or other programmable logic devices, discrete gate or transistor logic, discrete hardware components, or combinations thereof. A general purpose processor may be a microprocessor, or may be a conventional processor, controller, microcontroller, or state machine. The aforementioned electrical circuits may be configured by digital circuits or may be configured by analog circuits. Further, when integrated circuit technology replacing current integrated circuits appears due to progress in semiconductor technology, one or more aspects of the present disclosure can use new integrated circuits based on the technology.

What is claimed is:

1. An information processing apparatus comprising:
a display device; and
one or more controllers,
wherein the one or more controllers:
display a guidance screen, on the display device, for guiding use of a chat service; and
display, on the guidance screen, a message for guiding the use of the chat service on a terminal device and a display for causing the guidance screen to transition to a chat screen of the chat service.

2. The information processing apparatus according to claim 1, further comprising:
a short-range wireless communicator that communicates with the terminal device by short-range wireless communication,
wherein the one or more controllers display the message for prompting an operation on the short-range wireless communicator, on the guidance screen.

3. The information processing apparatus according to claim 2, wherein the one or more controllers:
generate connection information for using the chat service;
store the connection information in the short-range wireless communicator; and
transmit, when a transmission request for the connection information is received from the terminal device, the connection information to the terminal device via the short-range wireless communicator.

4. The information processing apparatus according to claim 3, wherein the one or more controllers delete the connection information after transmitting the connection information to the terminal device via the short-range wireless communicator.

5. The information processing apparatus according to claim 3, wherein the one or more controllers display, on the display device, an operation screen capable of accepting an operation after transmitting the connection information to the terminal device via the short-range wireless communicator.

6. The information processing apparatus according to claim 1, wherein, when a display for causing the guidance screen to transition to the chat screen of the chat service is selected, the one or more controllers display the chat screen on the display device.

7. The information processing apparatus according to claim 1, wherein the one or more controllers:
generate connection information for using the chat service;
generate a two-dimensional code based on the connection information; and
display, on the guidance screen, the two-dimensional code and the message prompting reading of the two-dimensional code with the terminal device.

8. A display system comprising:
a server device capable of providing a chat service;
an information processing apparatus displaying a guidance screen for guiding use of the chat service; and
a terminal device,
wherein the information processing apparatus displays, on the guidance screen, a message for guiding the use of the chat service on the terminal device and a display for causing the guidance screen to transition to a chat screen of the chat service.

9. The display system according to claim 8, wherein the server device ends provision of the chat service when display of the chat screen is ended in the information processing apparatus.

10. The display system according to claim 8, wherein the server device:
provides the chat service to the terminal device by communicating with the terminal device; and
ends provision of the chat service when communication with the terminal device is ended.

11. A display method comprising:
displaying a guidance screen for guiding use of a chat service; and
controlling for displaying, on the guidance screen, a message for guiding the use of the chat service on a terminal device and a display for causing the guidance screen to transition to a chat screen of the chat service.
